(19) United States
(12) Patent Application Publication
(10) Pub. No.: US 2024/0090497 A1
(43) Pub. Date: Mar. 21, 2024

(54) SURFACTANT BLENDS FOR HYPOHALITE-BASED DISINFECTING COMPOSITIONS

(71) Applicant: GOJO Industries, Inc., Akron, OH (US)

(72) Inventor: Marisa Macnaughtan, Pepper Pike, OH (US)

(21) Appl. No.: 18/470,859

(22) Filed: Sep. 20, 2023

Related U.S. Application Data
(60) Provisional application No. 63/408,225, filed on Sep. 20, 2022.

(51) Int. Cl. A01N 25/30; A01N 59/00; C11D 1/94; C11D 3/48

(52) U.S. Cl. CPC A01N 25/30; A01N 59/00; C11D 1/94; C11D 3/485; C11D 1/146

(57) ABSTRACT

Hypohalite-based disinfecting compositions are provided. The hypohalite-based disinfecting compositions comprise a source of chlorine, such as sodium hypochlorite, and a surfactant blend. The surfactant blend includes a first surfactant having a first surfactant surface tension T¹ and a second surfactant having a second surfactant surface tension T². The inventive disinfecting composition has an overall surface tension T that is less than the individual surfactant surface tensions T¹ and T², respectively.

### CROSS-REFERENCE TO RELATED APPLICATION(S)

This This application claims priority to and any benefit of U.S. Provisional Application No. 63/408,225, filed Sep. 20, 2022, the content of which is incorporated herein by reference in its entirety.

### FIELD

The present disclosure relates to hypohalite-based disinfecting compositions. More particularly, the present disclosure relates to surfactant blends for hypohalite-based disinfecting compositions that provide a desired surface tension.

### BACKGROUND

Bleach compositions are used by consumers for cleaning and disinfecting surfaces in the home or workplace. Such disinfection may be achieved via compositions in the form of wipes, disinfecting sprays, or bulk disinfectants. Regardless of form, users require disinfecting compositions that are safe to use, and that achieve broad-spectrum efficacy against harmful microorganisms, including pathogenic microorganisms. As such, the subject disinfecting compositions must have a low toxicity rating (e.g., be safe for the user) while providing rapid efficacy against bacteria, viruses, and fungi.

In environments specific to healthcare, serious infections are of particular concern. Such infections may be generally referred to as healthcare-associated infections (HAIs). While most types of HAIs are declining, one infection, caused by the bacteria Clostridioides difficile (i.e., Clostridium difficile) (“C. difficile” or “C. diff”), remains at historically high levels. C. difficile is a spore-forming, gram-positive anaerobic bacillus of the human intestine and is thought to be present in 2-5% of the adult population. Pathogenic C. difficile strains produce multiple toxins, the most well-characterized of which are enterotoxin (C. difficile toxin A) and cytotoxin (C. difficile toxin B), both of which can produce diarrhea and inflammation in infected patients. The emergence of a new, highly toxic strain of C. difficile, resistant to fluoroquinolone antibiotics such as ciprofloxacin and levofloxacin, has also been reported. C. difficile infections affect approximately half a million people per year in the United States.

Conventional bleach formulations include a source of chlorine, e.g., sodium hypochlorite, as the active ingredient diluted within a buffered liquid composition. While various bleach formulations have been found to provide a reduction against C. difficile spores on surfaces, the bleach formulations known in the art have been unable to meet desired standards of rapid efficacy against C. difficile spores. Specifically, a need exists for hypohalite-based disinfecting compositions that are delivered either in liquid form or via a wipe substrate, which achieve at least a 6-log reduction in C. difficile within 2 minutes or less. Moreover, in addition to the rapid efficacy, it is desirable for such compositions to maintain or exceed the current market demand for shelf life, human safety, and surface compatibility for bleach compositions.

### SUMMARY

The general inventive concepts are directed to hypohalite-based disinfecting compositions comprising greater than 0.5 wt. % of a hypohalite ingredient and a particular surfactant blend that provides a desired surface tension. The surfactant blend comprises a first surfactant having a first surfactant surface tension T¹ and a second surfactant having a second surfactant surface tension T². The second surfactant has an average tail chain length value that is different than the first surfactant, and the second surfactant has a head group that is different than the first surfactant. The inventive disinfecting composition has an overall surface tension T, wherein T is less than T¹, and wherein T is less than T².

### DESCRIPTION OF THE FIGURES

The advantages of the inventive concepts will be apparent upon consideration of the following detailed disclosure, especially when taken in conjunction with the accompanying drawings wherein:

FIG. 1 is a line plot showing the overall surface tension of otherwise identical hypohalite-based disinfecting compositions comprising varying levels of sodium lauryl sulfate and myristamine oxide (“SLS/MO”) surfactant blends.

FIG. 2 is a line plot showing the overall surface tension of otherwise identical hypohalite-based disinfecting compositions comprising varying levels of sodium myristyl sulfate and lauramine oxide (“SMS/LO”) surfactant blends.

FIG. 3 is a line plot showing the overall surface tension of otherwise identical hypohalite-based disinfecting compositions comprising varying levels of sodium lauryl sulfate and cocobetaine (“SLS/CB”) surfactant blends.

FIG. 4 is a line plot showing the overall surface tension of otherwise identical hypohalite-based disinfecting compositions comprising varying levels of sodium myristyl sulfate and cocobetaine (“SMS/CB”) surfactant blends.

FIG. 5 is a line plot showing the overall surface tension of otherwise identical hypohalite-based disinfecting compositions comprising varying levels of undeceth-3 and myristamine oxide (“UD3/MO”) surfactant blends.

FIG. 6 is a line plot showing the overall surface tension of otherwise identical hypohalite-based disinfecting compositions comprising varying levels of sodium lauryl sulfate and decyl glucoside (“SLS/DG”) surfactant blends.

FIG. 7 is a line plot provided for comparative purposes showing the overall surface tension of otherwise identical hypohalite-based disinfecting compositions comprising varying levels of lauramine oxide and laureth-6 (“LO/L6”) surfactant blends that do not meet the success criteria established for the inventive composition.

### DETAILED DESCRIPTION

Disclosed herein are hypohalite-based disinfecting compositions. While the present disclosure describes certain embodiments of the hypohalite-based disinfecting compositions in detail, the present disclosure is to be considered exemplary and is not intended to be limited to the disclosed embodiments.

The terminology as set forth herein is for description of the embodiments only and should not be construed as limiting the disclosure as a whole. All references to singular characteristics or limitations of the present disclosure shall include the corresponding plural characteristic or limitation, and vice versa, unless otherwise specified or clearly implied to the contrary by the context in which the reference is made. Unless otherwise specified, “a,” “an,” “the,” and “at least one” are used interchangeably. Furthermore, as used in the description and the appended claims, the singular forms “a,” “an,” and “the” are inclusive of their plural forms, unless the context clearly indicates otherwise.

To the extent that the term “includes” or “including” is used in the description or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use.

The hypohalite-based disinfecting compositions of the present disclosure can comprise, consist of, or consist essentially of the essential elements of the disclosure as described herein, as well as any additional or optional element described herein, or which is otherwise useful in disinfecting applications.

All percentages, parts, and ratios as used herein are by weight of the total formulation, unless otherwise specified.

All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all sub-ranges beginning with a minimum value of 1 or more and ending with a maximum value of 10 or less (e.g., 1 to 6.1, or 2.3 to 9.4), and to each integer (1, 2, 3, 4, 5, 6, 7, 8, 9, and 10) contained within the range.

Any combination of method or process steps as used herein may be performed in any order, unless otherwise specified or clearly implied to the contrary by the context in which the referenced combination is made.

The general inventive concepts relate to hypohalite-based disinfecting compositions. More particularly, the inventive concepts relate to sodium hypochlorite compositions containing a blend of two or more surfactants. In accordance with the present disclosure, the surfactant blend comprises at least two surfactants having different average tail lengths, i.e., a tail chain length distribution with a different average number of carbon units. Specifically, the surfactant blend comprises a first surfactant having a first surfactant surface tension T¹ and a second surfactant having a second surfactant surface tension T², wherein the second surfactant has an average tail chain length value that is different than the first surfactant, and wherein the second surfactant has a head group that is different than the first surfactant. The inventive disinfecting composition has an overall surface tension T, wherein T is less than T¹, and wherein T is less than T².

In accordance with the present disclosure, the hypohalite-based disinfecting compositions are characterized by the presence of an oxidant ingredient that forms free halite ions, i.e., a hypohalite ingredient. In accordance with the present disclosure, the oxidant ingredient comprises a source of free chlorine ions including, without limitation, chlorine dioxide decahydrate, sodium hypochlorite pentahydrate, chlorinated trisodium phosphate, an alkali metal hypochlorite or an alkaline earth metal hypochlorite selected from the group consisting of sodium, potassium, magnesium, lithium, or calcium hypochlorites, or mixtures thereof. In some embodiments, the oxidant ingredient comprises, or consists of, hypochlorous acid or a salt or derivative thereof. In some embodiments, the oxidant ingredient comprises a precursor to hypohalite salts, hypohalous acid or other halite ions. In some embodiments, the precursor is an organic chloramine complex, including, without limitation, dichloroisocyanuric acid, dichloroisocyanurate salt, trichloroisocyanuric acid, 1,3-dichloro-5,5-dimethylhydantoin, 1-bromo-3-chloro-5,5-dimethylhydantoins, 1,3 -dibromo-5,5-dimethylhydantoin, trichloromelamine, and N-chloro-aryl-sulfonamides. In some embodiments, the oxidant ingredient comprises, or consists of, a hypochlorite. In some embodiments, the oxidant ingredient is selected from the group consisting of sodium hypochlorite and potassium hypochlorite. In some embodiments, the oxidant ingredient comprises, or consists of, sodium hypochlorite.

In accordance with the present disclosure, the hypohalite-based disinfecting composition comprises greater than 0.5 wt. % of a hypohalite ingredient, based upon the total weight of the hypohalite-based disinfecting composition. In some embodiments, the hypohalite-based disinfecting composition comprises 0.55 wt. % or greater of a hypohalite ingredient, including 0.6 wt. % or greater, including 0.65 wt. % or greater, including 0.7 wt. % or greater, including 0.75 wt. % or greater, based upon the total weight of the hypohalite-based disinfecting composition. In some embodiments, the hypohalite-based disinfecting composition comprises from greater than 0.5 to 2 wt. % of a hypohalite ingredient, including from 0.55 to 1.9 wt.%, including from 0.6 to 1.8 wt. %, including from 0.65 to 1.5 wt. %, including from 0.7 to 1.3 wt.%, including from 0.75 to 1.2 wt. %, based upon the total weight of the hypohalite-based disinfecting composition. The concentration of the hypohalite ingredient may also be expressed in terms of parts per million (ppm) within the hypohalite-based disinfecting composition. Accordingly, in some embodiments, the hypohalite-based disinfecting composition comprises greater than 5,000 ppm of the hypohalite ingredient, including 5,500 ppm or greater, including 6,000 ppm or greater, including 6,500 ppm or greater, including 7,000 ppm or greater, including 7,500 ppm or greater. In some embodiments, the hypohalite-based disinfecting composition comprises from greater than 5,000 to 20,000 ppm of the hypohalite ingredient, including from 5,500 to 19,000 ppm, including from 6,000 to 18,000 ppm, including from 6,500 to 15,000 ppm, including from 7,000 to 13,000 ppm, including from 7,500 to 12,000 ppm.

In accordance with the present disclosure, the hypohalite-based disinfecting compositions comprise a surfactant blend, or said otherwise, a blend of two or more different surfactants. In some embodiments, the surfactant blend consists of two surfactants, i.e., a first surfactant and a second surfactant. In some embodiments, the surfactant blend consists of three surfactants.

In accordance with the present disclosure, the hypohalite-based disinfecting composition comprises 0.1 wt. % or less of the surfactant blend, based upon the total weight of the hypohalite-based disinfecting composition. In some embodiments, the hypohalite-based disinfecting composition comprises 0.09 wt. % or less of the surfactant blend, including 0.075 wt.% or less, including 0.06 wt. % or less, including 0.05 wt. % or less, including 0.03 wt. % or less, based upon the total weight of the hypohalite-based disinfecting composition. In some embodiments, the hypohalite-based disinfecting composition comprises from 0.005 to 0.1 wt. % of the surfactant blend, including from 0.01 to 0.09 wt. %, including from 0.01 to 0.075 wt. %, including from 0.01 to 0.05 wt. %, including from 0.01 to 0.04 wt. %, including from 0.01 to 0.03 wt. %, based upon the total weight of the hypohalite-based disinfecting composition. As set forth in this paragraph, the “wt. % of the surfactant blend” means the total concentration of the surfactants within the hypohalite-based disinfecting composition, based upon the total weight of the hypohalite -based disinfecting composition. The concentration of the surfactant blend may also be expressed in terms of parts per million (ppm) within the hypohalite-based disinfecting composition. Accordingly, in some embodiments, the hypohalite-based disinfecting composition comprises 1,000 ppm or less of the surfactant blend, including 900 ppm or less, including 750 ppm or less, including 600 ppm or less, including 500 ppm or less, including 300 ppm or less. In some embodiments, the hypohalite-based disinfecting composition comprises from 50 to 1,000 ppm of the surfactant blend, including from 100 to 900 ppm, including from 100 to 750 ppm, including from 100 to 500 ppm, including from 100 to 400 ppm, including from 100 to 300 ppm.

In some embodiments, the surfactant blend comprises at least two surfactants having different average tail lengths, i.e., a tail chain length distribution with a different average number of carbon units. In some embodiments, the surfactant blend consists of two surfactants, wherein the two surfactants have different average tail lengths. In some embodiments, the surfactant blend comprises at least two surfactants having different head groups. In some embodiments, the surfactant blend comprises, or consists of, two surfactants, wherein the two surfactants have different head groups. In some embodiments, the surfactant blend comprises, or consists of, two surfactants, wherein the two surfactants have different average tail lengths and different head groups. In some embodiments, the surfactant blend consists of two surfactants, wherein the first surfactant has an average tail chain length of a C10 to C14 value and the second surfactant has an average tail chain length of a different C10 to C14 value than the first surfactant. In some embodiments, the surfactant blend consists of two surfactants, wherein the first surfactant has an average tail chain length of a C12 to C14 value and the second surfactant has an average tail chain length of a different C12 to C14 value than the first surfactant. In some embodiments, the surfactant blend consists of two surfactants, wherein the first surfactant has an average tail chain length of C12 and the second surfactant has an average tail chain length of C14. One surprising feature of the present invention is the enhanced efficacy provided by the blend of two surfactants having different average tail lengths, i.e., a tail chain length distribution with a different average number of carbon units. Specifically, the combination of sodium lauryl sulfate, having a C12 average tail length, and myristamine oxide, having a C14 average tail length, has been found to have a synergistic effect, i.e., more than just an additive effect, on the efficacy of the inventive composition. Other synergistic combinations include, without limitation: the combination of sodium myristyl sulfate, having a C14 average tail length, and lauramine oxide, having a C12 average tail length; the combination of sodium lauryl sulfate, having a C12 average tail length, and cocobetaine, having a C12.7 average tail length; and the combination of sodium myristyl sulfate, having a C14 average tail length, and cocobetaine, having a C12.7 average tail length.

In accordance with the present disclosure, the surfactant blend comprises anionic, zwitterionic, or nonionic surfactants. The term “amphoteric” surfactant is often used interchangeably with the term “zwitterionic” surfactant, i.e. each term has the identical meaning of surfactants having both cationic and anionic centers attached to the same molecule. In some embodiments, the surfactant blend comprises at least one anionic surfactant and at least one surfactant comprising a zwitterionic or a nonionic surfactant. In some embodiments, the surfactant blend comprises, or consists of, two surfactants, wherein the first surfactant is an anionic surfactant and the second surfactant is selected from the group consisting of a zwitterionic or a nonionic surfactant. In some embodiments, the surfactant blend comprises, or consists of, two surfactants, wherein the first surfactant is an anionic surfactant and the second surfactant is a zwitterionic surfactant. In some embodiments, the surfactant blend comprises, or consists of, two surfactants, wherein the first surfactant is an anionic surfactant and the second surfactant is a nonionic surfactant. In some embodiments, the surfactant blend comprises, or consists of, two surfactants, wherein the first surfactant is a nonionic surfactant and the second surfactant is a zwitterionic surfactant. In some embodiments, the hypohalite-based disinfecting compositions are devoid of cationic surfactants. In some embodiments, the hypohalite-based disinfecting compositions are devoid of quaternary ammonium compounds, commonly known in the art as “quats,” including, without limitation, quaternary ammonium chlorides. In some embodiments, the hypohalite-based disinfecting compositions are devoid of nonionic surfactants.

In accordance with the present disclosure, the surfactant blend may comprise one or more anionic surfactants. In some embodiments, the anionic surfactant may comprise one or more sulfates, including, but not limited to, sodium alkyl sulfate, sodium octyl sulfate, sodium nonyl sulfate, sodium decyl sulfate, sodium undecyl sulfate, sodium lauryl sulfate, sodium dodecyl sulfate, sodium tridecyl sulfate, sodium tetradecyl sulfate, sodium myristyl sulfate, sodium pentadecyl sulfate, sodium hexadecyl sulfate, sodium heptadecyl sulfate, sodium octodecyl sulfate, potassium lauryl sulfate, ammonium lauryl sulfate, magnesium lauryl sulfate, sodium 2-ethylhexyl sulfate, or any other branched alkyl groups or salts; one or more carboxylates, including, but not limited to, sodium caprylate, sodium pelargonate, sodium caprate, sodium undecylate, sodium laurate, sodium tridecylate, sodium myristate, sodium pentadecylate, sodium palmitate, sodium margarate, sodium stearate, or other salts (including, but not limited to, potassium, barium, calcium, magnesium, ammonium, and tetraalkyl ammoniums); one or more sulfonates, including, but not limited to sodium nonanoyl oxybenzene sulfonate, sodium dodecylbenzene sulfonate, alpha olefin sulfonate, alkyl sulfonates, alkyl/aryl sulfonates, alkyldiphenyloxide disulfonates, sulphated esters, sulphated alkanolamides, and alkylphenols; one or more phosphates, including, but not limited to, alkyl-aryl ether phosphates, alkyl ether phosphates; sulfosuccinates; sarcosinates; sodium lauryl sarcosinate, alkyl-ether sulfates; sodium laureth sulfate, ammonium laureth sulfate, magnesium laureth sulfate, sodium myreth sulfate; or mixtures thereof. In some embodiments, the anionic surfactant comprises, or consists of, one or more of sodium dodecyl sulfate, sodium tetradecyl sulfate, sodium laurate, sodium myristate, or combinations thereof. In some embodiments, the anionic surfactant comprises, or is selected from the group consisting of, sodium lauryl sulfate (“SLS”) and sodium myristyl sulfate (“SMS”). In some embodiments, the anionic surfactant comprises, or consists of, sodium lauryl sulfate (“SLS”). In some embodiments, the anionic surfactant comprises, or consists of, sodium myristyl sulfate (“SMS”).

In accordance with the present disclosure, the hypohalite-based disinfecting composition comprises less than 0.07 wt. % of one or more anionic surfactants, based upon the total weight of the hypohalite-based disinfecting composition. In some embodiments, the hypohalite-based disinfecting composition comprises 0.065 wt. % or less of one or more anionic surfactants, including 0.06 wt. % or less, including 0.05 wt. % or less, including 0.04 wt. % or less, including 0.03 wt. % or less, based upon the total weight of the hypohalite-based disinfecting composition. In some embodiments, the hypohalite-based disinfecting composition comprises from 0.001 to 0.07 wt. % of one or more anionic surfactants, including from 0.002 to 0.06 wt. %, including from 0.003 to 0.05 wt. %, including from 0.004 to 0.04 wt. %, including from 0.005 to 0.035 wt. %, including from 0.01 to 0.03 wt. %, based upon the total weight of the hypohalite-based disinfecting composition. The concentration of the one or more anionic surfactants may also be expressed in terms of parts per million (ppm) within the hypohalite-based disinfecting composition. Accordingly, in some embodiments, the hypohalite-based disinfecting composition comprises less than 700 ppm of one or more anionic surfactants, including 650 ppm or less, including 600 ppm or less, including 500 ppm or less, including 400 ppm or less, including 300 ppm or less. In some embodiments, the hypohalite-based disinfecting composition comprises from 10 to 700 ppm of one or more anionic surfactants, including from 20 to 600 ppm, including from 30 to 500 ppm, including from 40 to 400 ppm, including from 50 to 350 ppm, including from 100 to 300 ppm.

In accordance with the present disclosure, the hypohalite-based disinfecting composition comprises less than 0.07 wt. % of sodium lauryl sulfate (“SLS”), based upon the total weight of the hypohalite-based disinfecting composition. In some embodiments, the hypohalite-based disinfecting composition comprises 0.065 wt. % or less of SLS, including 0.06 wt. % or less, including 0.05 wt. % or less, including 0.04 wt. % or less, including 0.03 wt. % or less, based upon the total weight of the hypohalite-based disinfecting composition. In some embodiments, the hypohalite-based disinfecting composition comprises from 0.001 to 0.07 wt. % of SLS, including from 0.002 to 0.06 wt. %, including from 0.003 to 0.05 wt. %, including from 0.004 to 0.04 wt.%, including from 0.005 to 0.035 wt. %, including from 0.01 to 0.03 wt. %, based upon the total weight of the hypohalite-based disinfecting composition. The concentration of the SLS surfactant may also be expressed in terms of parts per million (ppm) within the hypohalite-based disinfecting composition. Accordingly, in some embodiments, the hypohalite-based disinfecting composition comprises less than 700 ppm of SLS, including 650 ppm or less, including 600 ppm or less, including 500 ppm or less, including 400 ppm or less, including 300 ppm or less. In some embodiments, the hypohalite-based disinfecting composition comprises from 10 to 700 ppm of SLS, including from 20 to 600 ppm, including from 30 to 500 ppm, including from 40 to 400 ppm, including from 50 to 350 ppm, including from 100 to 300 ppm.

In accordance with the present disclosure, the hypohalite-based disinfecting composition comprises less than 0.07 wt. % of sodium myristyl sulfate (“SMS”), based upon the total weight of the hypohalite-based disinfecting composition. In some embodiments, the hypohalite-based disinfecting composition comprises 0.065 wt. % or less of SMS, including 0.06 wt. % or less, including 0.05 wt. % or less, including 0.04 wt. % or less, including 0.03 wt. % or less, based upon the total weight of the hypohalite-based disinfecting composition. In some embodiments, the hypohalite-based disinfecting composition comprises from 0.001 to 0.07 wt. % of SMS, including from 0.002 to 0.06 wt. %, including from 0.003 to 0.05 wt. %, including from 0.004 to 0.04 wt. %, including from 0.005 to 0.035 wt. %, including from 0.01 to 0.03 wt. %, based upon the total weight of the hypohalite-based disinfecting composition. The concentration of the SMS surfactant may also be expressed in terms of parts per million (ppm) within the hypohalite-based disinfecting composition. Accordingly, in some embodiments, the hypohalite-based disinfecting composition comprises less than 700 ppm of SMS, including 650 ppm or less, including 600 ppm or less, including 500 ppm or less, including 400 ppm or less, including 300 ppm or less. In some embodiments, the hypohalite-based disinfecting composition comprises from 10 to 700 ppm of SMS, including from 20 to 600 ppm, including from 30 to 500 ppm, including from 40 to 400 ppm, including from 50 to 350 ppm, including from 100 to 300 ppm.

In accordance with the present disclosure, the surfactant blend may comprise one or more zwitterionic surfactants. In some embodiments, the zwitterionic surfactant may comprise one or more of C8-C18 alkyl amine oxides, such as dimethyl decylamine oxide, dimethyl lauramine oxide, dimethyl myristyl amine oxide, lauryl/myristyl amidopropyl amine oxide, decylamine oxide, or cocamidopropylamine oxide; one or more C8-C18 betaines, such as cocobetaine; one or more C12 betaines; one or more sultaines, or combinations thereof. In some embodiments, the zwitterionic surfactant comprises, or is selected from the group consisting of, myristamine oxide, lauramine oxide, and cocobetaine. In some embodiments, the hypohalite-based disinfecting composition is devoid of lauramine oxide. In some embodiments, the zwitterionic surfactant comprises, or is selected from the group consisting of, myristamine oxide and cocobetaine. In some embodiments, the zwitterionic surfactant comprises, or consists of, myristamine oxide. In some embodiments, the zwitterionic surfactant comprises, or consists of, cocobetaine.

In accordance with the present disclosure, the hypohalite-based disinfecting composition comprises less than 0.03 wt. % of one or more zwitterionic surfactants, based upon the total weight of the hypohalite-based disinfecting composition. In some embodiments, the hypohalite-based disinfecting composition comprises 0.025 wt. % or less of one or more zwitterionic surfactants, including 0.02 wt. % or less, including 0.015 wt. % or less, including 0.0125 wt. % or less, including 0.01 wt. % or less, based upon the total weight of the hypohalite-based disinfecting composition. In some embodiments, the hypohalite-based disinfecting composition comprises from 0.001 to 0.03 wt. % of one or more zwitterionic surfactants, including from 0.002 to 0.025 wt. %, including from 0.0025 to 0.02 wt. %, including from 0.003 to 0.015 wt. %, including from 0.005 to 0.0125 wt. %, including from 0.005 to 0.01 wt. %, based upon the total weight of the hypohalite-based disinfecting composition. The concentration of the one or more zwitterionic surfactants may also be expressed in terms of parts per million (ppm) within the hypohalite-based disinfecting composition. Accordingly, in some embodiments, the hypohalite-based disinfecting composition comprises less than 300 ppm of one or more zwitterionic surfactants, including 250 ppm or less, including 200 ppm or less, including 150 ppm or less, including 125 ppm or less, including 100 ppm or less. In some embodiments, the hypohalite-based disinfecting composition comprises from 10 to 300 ppm of one or more zwitterionic surfactants, including from 20 to 250 ppm, including from 25 to 200 ppm, including from 30 to 150 ppm, including from 50 to 125 ppm, including from 50 to 100 ppm.

In accordance with the present disclosure, the hypohalite-based disinfecting composition comprises less than 0.03 wt. % of myristamine oxide, based upon the total weight of the hypohalite-based disinfecting composition. In some embodiments, the hypohalite-based disinfecting composition comprises 0.025 wt. % or less of myristamine oxide, including 0.02 wt. % or less, including 0.015 wt. % or less, including 0.0125 wt. % or less, including 0.01 wt. % or less, based upon the total weight of the hypohalite-based disinfecting composition. In some embodiments, the hypohalite-based disinfecting composition comprises from 0.001 to 0.03 wt. % of myristamine oxide, including from 0.002 to 0.025 wt. %, including from 0.0025 to 0.02 wt. %, including from 0.003 to 0.015 wt. %, including from 0.005 to 0.0125 wt. %, including from 0.005 to 0.01 wt. %, based upon the total weight of the hypohalite-based disinfecting composition. The concentration of the myristamine oxide surfactant may also be expressed in terms of parts per million (ppm) within the hypohalite-based disinfecting composition. Accordingly, in some embodiments, the hypohalite-based disinfecting composition comprises less than 300 ppm of myristamine oxide, including 250 ppm or less, including 200 ppm or less, including 150 ppm or less, including 100 ppm or less. In some embodiments, the hypohalite-based disinfecting composition comprises from 10 to 300 ppm of myristamine oxide, including from 20 to 250 ppm, including from 25 to 200 ppm, including from 30 to 150 ppm, including from 50 to 125 ppm, including from 50 to 100 ppm.

In accordance with the present disclosure, the hypohalite-based disinfecting composition comprises less than 0.03 wt. % of cocobetaine, based upon the total weight of the hypohalite-based disinfecting composition. In some embodiments, the hypohalite-based disinfecting composition comprises 0.025 wt. % or less of cocobetaine, including 0.02 wt. % or less, including 0.015 wt. % or less, including 0.0125 wt. % or less, including 0.01 wt. % or less, based upon the total weight of the hypohalite-based disinfecting composition. In some embodiments, the hypohalite-based disinfecting composition comprises from 0.001 to 0.03 wt. % of cocobetaine, including from 0.002 to 0.025 wt. %, including from 0.0025 to 0.02 wt. %, including from 0.003 to 0.015 wt. %, including from 0.005 to 0.0125 wt. %, including from 0.005 to 0.01 wt. %, based upon the total weight of the hypohalite-based disinfecting composition. The concentration of the cocobetaine surfactant may also be expressed in terms of parts per million (ppm) within the hypohalite-based disinfecting composition. Accordingly, in some embodiments, the hypohalite-based disinfecting composition comprises less than 300 ppm of cocobetaine, including 250 ppm or less, including 200 ppm or less, including 150 ppm or less, including 100 ppm or less. In some embodiments, the hypohalite-based disinfecting composition comprises from 10 to 300 ppm of cocobetaine, including from 20 to 250 ppm, including from 25 to 200 ppm, including from 30 to 150 ppm, including from 50 to 125 ppm, including from 50 to 100 ppm.

In some embodiments of the present disclosure, the surfactant blend may comprise one or more nonionic surfactants including, but not limited to, ethoxylates, alkylphenol ethoxylates, ethoxylated amines, propoxylates, propoxylate/ethoxylates, alkyl polyglucosides, or combinations thereof. In some embodiments, the nonionic surfactant comprises, or consists of, laureth-6. In some embodiments, the nonionic surfactant comprises, or consists of, undeceth-3. In some embodiments, the nonionic surfactant comprises, or consists of, decyl glucoside. In some embodiments of the present disclosure, the hypohalite-based disinfecting composition is devoid of nonionic surfactants.

In accordance with the present disclosure, the hypohalite-based disinfecting compositions comprise a surfactant blend having a particular molar ratio of surfactants. In some embodiments, the surfactant blend consists of two surfactants, wherein the first surfactant is an anionic surfactant, and the second surfactant is a zwitterionic surfactant. In some embodiments, the molar ratio of anionic surfactant to zwitterionic surfactant (i.e., [anionic surfactant]: [zwitterionic surfactant]) is from 10:1 to 1:10, including from 9:1 to 1:9, including from 7:1 to 1:7, including from 5:1 to 1:5, including from 4:1 to 1:4, including from 3:1 to 1:3. In some embodiments, the surfactant blend consists of a blend of sodium lauryl sulfate (“SLS”) and myristamine oxide (“MO”), wherein the molar ratio of sodium lauryl sulfate to myristamine oxide (i.e., [SLS]:[MO] is from 10:1 to 1:10, including from 9:1 to 1:9, including from 7:1 to 1:7, including from 5:1 to 1:5, including from 4:1 to 1:4, including from 3:1 to 1:3. In some embodiments, the surfactant blend consists of a blend of sodium myristyl sulfate (“SMS”) and lauramine oxide (“LO”), wherein the molar ratio of sodium myristyl sulfate to lauramine oxide (i.e., [SMS]:[LO] is from 10:1 to 1:10, including from 9:1 to 1:9, including from 7:1 to 1:7, including from 5:1 to 1:5, including from 4:1 to 1:4, including from 3:1 to 1:3. In some embodiments, the surfactant blend consists of a blend of SLS and cocobetaine (“CB”), wherein the molar ratio of SLS to cocobetaine (i.e., [SLS]: [CB]) is from 10:1 to 1:10, including from 9:1 to 1:9, including from 7:1 to 1:7, including from 5:1 to 1:5, including from 4:1 to 1:4, including from 3:1 to 1:3. In some embodiments, the surfactant blend consists of a blend of SMS and CB, wherein the molar ratio of SMS to CB (i.e., [SMS]: [CB]) is from 10:1 to 1:10, including from 9:1 to 1:9, including from 7:1 to 1:7, including from 5:1 to 1:5, including from 4:1 to 1:4, including from 3:1 to 1:3.

In accordance with the present disclosure, the hypohalite-based disinfecting composition may comprise a particular weight ratio of surfactant to hypohalite ingredient. In some embodiments, the weight ratio of total surfactants in the composition to the hypohalite ingredient (i.e., [wt. %surfactant blend]: [wt. % hypohalite ingredient]), based on the total weight of the hypohalite-based disinfecting composition, is below 1:1, including 0.95:1 or less, including 0.9:1 or less, including from 0.01:1 to 0.95:1, including from 0.01:1 to 0.5:1, including from 0.025:1 to 0.035:1. In some embodiments, the surfactant blend comprises a blend of sodium lauryl sulfate and myristamine oxide, and the hypohalite ingredient comprises sodium hypochlorite, wherein the weight ratio of surfactant blend to sodium hypochlorite, based on the total weight of the hypohalite-based disinfecting composition is below 1:1, including 0.95:1 or less, including 0.9:1 or less, including from 0.01:1 to 0.95:1, including from 0.01:1 to 0.5:1, including from 0.025:1 to 0.035:1.

In accordance with the present disclosure, the hypohalite-based disinfecting compositions comprise one or more buffers. In some embodiments, the hypohalite-based disinfecting compositions comprise, or consist of, two buffers. Exemplary buffers include, but are not limited to, carbonates, bicarbonates, silicates, boric acid, borates, phosphates, phosphoric acid, sulfuric acid, sodium bisulfate, hydrochloric acid, sodium hydroxide, monocarboxylic acid, polycarboxylic acid, polyphosphates or polyphosphoric acids, salts of any of the foregoing, derivatives of any of the foregoing, or mixtures of any of the foregoing. In some embodiments, the one or more buffers comprise alkali metal salts of carbonates, bicarbonates, polycarbonates, phosphates, phosphoric acid, polyphosphates, polyphosphoric acid, or mixtures of any of the foregoing.

In accordance with the present disclosure, the hypohalite-based disinfecting composition comprises from 0.001 to 1 wt. % of the one or more buffers, including from 0.002 to 0.9 wt. %, including from 0.005 to 0.8 wt. %, including from 0.005 to 0.75 wt. %, including from 0.015 to 0.7 wt. %, including from 0.02 to 0.6 wt. %, based upon the total weight of the hypohalite-based disinfecting composition. The concentration of the one or more buffers may also be expressed in terms of parts per million (ppm) within the hypohalite-based disinfecting composition. Accordingly, in some embodiments, the hypohalite-based disinfecting composition comprises from 10 to 10,000 ppm of the one or more buffers, including from 20 to 9,000 ppm, including from 50 to 8,000 ppm, including from 50 to 7,500 ppm, including from 150 to 7,000 ppm, including from 200 to 6,000 ppm.

In accordance with the present disclosure, the hypohalite-based disinfecting composition may comprise one or more alkaline pH adjusting agents in addition to the one or more buffers. In general, the term “alkaline pH adjusting agent” as used herein refers to any compound that interacts with water to create an OH⁽⁻⁾ ion. Suitable alkaline pH adjusting agents include, but are not limited to, hydroxides such as sodium hydroxide, potassium hydroxide, calcium hydroxide, lithium hydroxide, magnesium hydroxide, ammonium hydroxide, tetraalkylammonium hydroxide, tetraarylammonium hydroxide, choline hydroxide, and combinations thereof; metal oxides such as calcium oxide, magnesium oxide, and sodium oxide; sodium alkoxides, potassium alkoxides, sodium aryloxides, and like compounds having a sodium, potassium, lithium, calcium or magnesium cation. In some embodiments, the one or more alkaline pH adjusting agents comprise, or consist of, one or more of potassium hydroxide and sodium hydroxide. In some embodiments, the one or more alkaline pH adjusting agents comprise, or consist of, sodium hydroxide. In other embodiments, the hypohalite-based disinfecting composition is devoid of pH adjusting agents other than the inventive blend of buffers. In some embodiments, the hypohalite-based disinfecting composition is devoid of added hydroxides. In some embodiments, the hypohalite-based disinfecting composition is devoid of sodium hydroxide and potassium hydroxide.

In accordance with the present disclosure, the hypohalite-based disinfecting compositions have a pH of greater than 9, including greater than 9.5, including greater than 10, including greater than 10.5, including greater than 11, including greater than 11.5. In some embodiments, the hypohalite-based disinfecting compositions have a pH of less than 14, including less than 13.5, including less than 13, including less than 12.5, including less than 12, including less than 11. In some embodiments, the hypohalite-based disinfecting compositions have a pH of from 9 to 13, including from 9 to 12, including from 9.5 to less than 12, including from 9.6 to 11.7, including from 9.6 to 11.6, including from 10 to 11.5.

In accordance with the present disclosure, the hypohalite-based disinfecting compositions may comprise a number of optional ingredients comprising corrosion inhibitors, hydrotropes, or chaotropes. Exemplary optional ingredients include, but are not limited to, sodium silicate, sodium or potassium benzoate, zinc salts, sodium or zinc polyacrylates, calcium salts, magnesium salts, sodium xylene sulfonate, sodium benzene sulfonate, sodium toluene sulfonate, sodium alkonates, colatrope, or phosphate esters. In some embodiments, the hypohalite-based disinfecting compositions are devoid of added corrosion inhibitors, devoid of added hydrotropes, or devoid of added chaotropes. In some embodiments, the hypohalite-based disinfecting compositions are devoid of quaternary ammonium compounds. In some embodiments, the hypohalite-based disinfecting compositions are devoid of silicate ingredients. In some embodiments, the hypohalite-based disinfecting compositions are devoid of sulfonate ingredients. In some embodiments, the hypohalite-based disinfecting compositions are devoid of small molecule sulfonate ingredients. In some embodiments, the hypohalite-based disinfecting compositions are devoid of sodium xylene sulfonate. In some embodiments, the hypohalite-based disinfecting compositions may comprise one or more fragrance ingredients.

In accordance with the present disclosure, the hypohalite-based disinfecting compositions comprise water quantum sufficit (q.s.). In some embodiments, the hypohalite-based disinfecting compositions comprise at least 80 wt. % water. In some embodiments, the hypohalite-based disinfecting compositions comprise at least 90 wt. % water. In some embodiments, the hypohalite-based disinfecting compositions comprise at least 95 wt. % water. In some embodiments, the hypohalite-based disinfecting compositions comprise at least 96 wt. % water. In some embodiments, the hypohalite-based disinfecting compositions comprise at least 97 wt. % water. In some embodiments, the hypohalite-based disinfecting compositions comprise at least 98 wt. % water. In some embodiments, the hypohalite-based disinfecting compositions comprise from 80 to 99 wt. % water. In some embodiments, the hypohalite-based disinfecting compositions comprise from 90 to 99 wt. % water. In some embodiments, the hypohalite-based disinfecting compositions comprise from 90 to 98 wt. % water. In some embodiments, the hypohalite-based disinfecting compositions comprise from 95 to 98 wt. % water. In some embodiments, the hypohalite-based disinfecting compositions comprise from 96 to 98 wt. % water. In some embodiments, the hypohalite-based disinfecting compositions comprise from 97 to 98 wt. % water. More or less water may be required in certain instances, depending particularly on other ingredients and/or the amounts thereof employed.

The United States Environmental Protection Agency (EPA) publishes guidance regarding the efficacy of a composition against C. difficile spores. Specifically, the EPA publishes the “Standard Operating Procedure for Quantitative Disk Carrier Test Method (QCT-2) Modified for Testing Antimicrobial Products Against Spores of Clostridium difficile (ATCC 43598) on Inanimate, Hard, Non-porous Surfaces” (SOP Number: MB-31-03) (Date Revised: Jun. 12, 2014). The EPA regulates that the scope of the QCT-2 quantitative method is to evaluate the sporicidal efficacy of liquid disinfectants against C. diff spores, based upon the ASTM Standard E2197-11. Specifically, the published EPA guidance teaches that the QCT-2 test method is used to generate the log reduction values of viable spores of C. diff. Unless otherwise specified, the term “log reduction” as used herein in accordance with EPA standards refers to a log10 average reduction. Likewise in accordance with the noted EPA standards, the log reductions set forth in the instant disclosure are based upon the application of 50 μl of solution under the QCT-2 protocol.

In accordance with the present disclosure, the inventive hypohalite-based disinfecting compositions provide at least a 3-log reduction in C. difficile spores within 10 minutes, including within 5 minutes, including within 3 minutes, including within 2 minutes, including within less than 2 minutes, including within 110 seconds, including within 105 seconds, including within 90 seconds, including within 80 seconds, including within 60 seconds. In accordance with the present disclosure, the inventive hypohalite-based disinfecting compositions provide at least a 5-log reduction in C. difficile spores within 10 minutes, including within 5 minutes, including within 3 minutes, including within 2 minutes, including within less than 2 minutes, including within 110seconds, including within 105 seconds, including within 90 seconds, including within 80 seconds, including within 60 seconds. In accordance with the present disclosure, the inventive hypohalite-based disinfecting compositions provide at least a 6-log reduction in C. difficile spores within 10 minutes, including within 5 minutes, including within 3 minutes, including within 2 minutes, including within less than 2 minutes, including within 110 seconds, including within 105 seconds, including within 90 seconds, including within 80 seconds, including within 60 seconds.

The ability of the inventive hypohalite-based disinfecting compositions to provide at least a 3-log reduction, at least a 5-log reduction, and even as high as at least a 6-log reduction, in C. difficile spores within 2 minutes, or less, is a particularly surprising feature of the instant invention. A 6-log reduction correlates to a 99.9999% reduction in C. difficile spores. Without being bound by theory, it has been surprisingly found that intentionally blending two or more surfactants having different average tail lengths leads to the superior rapid efficacy against C. diff. of the composition as compared to an otherwise identical composition comprising either one surfactant, or else two or more surfactants having identical average tail lengths.

In addition to efficacy against C. difficile spores, the hypohalite-based disinfecting compositions disclosed herein are effective in removing unwanted contaminants including, but not limited to, soils, particulates, allergens, living or non-living contaminants, harmful microorganisms, non-enveloped and enveloped viruses, spores, Gram negative and Gram positive bacteria, fungi, yeast, mold, and pathogenic microorganisms. In some embodiments, the hypohalite-based disinfecting compositions have efficacy against bacteria such as Staphylococcus aureus, methicillin-resistant S. aureus, Escherichia coli, Pseudomonas aeruginosa, Serratia marcescens, Tuberculosis, yeast such as Candida albicans and/or Candida auris, mold such as Aspergillus niger, fungi such as Trichophyton mentagrophytes, enveloped viruses including Influenza A virus and coronavirus, and non-enveloped viruses including Respiratory syncytial virus, Rhinovirus, Norovirus, Feline Calicivirus, and Hepatitis A. In some embodiments, the hypohalite-based disinfecting compositions have efficacy against bacterial spores in addition to Clostridium difficile, such as Bacillus anthracis.

The inventive hypohalite-based disinfecting compositions exhibit an improved (i.e., lower) surface tension in comparison to conventional bleach formulations. The surface tension of a liquid impacts the fluid coverage when applied to a surface. For example, fluid coverage may exhibit partial surface wetting, due to the formation of spherical droplets, or beads, spaced apart from one another on the surface. This phenomenon correlates to a high surface tension. Conversely, fluid coverage may exhibit complete wetting, through the formation of a thin, evenly spread liquid “film” that results from the coalescence of the liquid droplets. This phenomenon correlates to a low surface tension. In addition, a low surface tension provides better and faster wetting of organic pathogens and soil, which allows for faster kill times of the pathogens.

It has been surprisingly found that intentionally blending two or more surfactants having different average tail lengths leads to the superior (i.e., lower) surface tension of the composition as compared to an otherwise identical composition comprising either one surfactant, or else two or more surfactants having identical average tail lengths. Specifically, it has been found that selecting a first surfactant having a first surfactant surface tension T¹ and a second surfactant having a second surfactant surface tension T², wherein the second surfactant has an average tail chain length that is different than the first surfactant, and wherein the second surfactant has a head group that is different than the first surfactant, surprisingly provides a disinfecting composition that has an overall surface tension T, wherein T is less than T¹, and wherein T is less than T². In quantitative terms, in accordance with the present disclosure, the difference between T and T¹ is 0.8 mN/m or more and the difference between T and T² is 0.8 mN/m or more. In some embodiments, the difference between T and T¹ is 1 mN/m or more and the difference between T and T² is 1 mN/m or more. In some embodiments, the difference between T and T¹ is 1.5 mN/m or more and the difference between T and T² is 1.5 mN/m or more. In some embodiments, the difference between T and T¹ is 2 mN/m or more and the difference between T and T² is 2 mN/m or more. Said otherwise, in accordance with the present disclosure, both T¹-T and T²-T, individually, are 0.8 mN/m or more, including 1 mN/m or more, including 1.5 mN/m or more, including 2 mN/m or more. Said otherwise, in accordance with the present disclosure, both T¹-T and T²-T≥0.8 mN/m. In some embodiments, both T¹-T and T²-T≥1 mN/m. In some embodiments, both T¹-T and T²-T≥1.5 mN/m. In some embodiments, both T¹-T and T²-T≥2 mN/m.

In accordance with the present disclosure, the inventive hypohalite-based disinfecting compositions have an overall surface tension T of 28 mN/m or less, including 27.8 mN/m or less, including 27.5 mN/m or less, including 27 mN/m or less, including 26.8 mN/m or less, including 26.5 mN/m or less, including an overall surface tension of from 24 to 28 mN/m, including from 24 to less than 28 mN/m, including from 25 to 28 mN/m, including from 25 to less than 28 mN/m, including from 24.5 to 27.5 mN/m, including from 25 to 27 mN/m.

Further improvements to the spreadability of the inventive hypohalite-based disinfecting composition result from the composition's reduced contact angle. The contact angle is a measurement of the angle of incidence between a surface and a liquid. For instance, water has a high contact angle and will sit as a droplet on a surface, while ethanol has a low contact angle and will quickly spread into cracks or crevices of the surface. A lower contact angle means that a formulation has superior wetting and spreading on a surface.

In accordance with the present disclosure, the inventive hypohalite-based disinfecting compositions have an equilibrium contact angle of less than 79° when applied to an exemplary hydrophobic polytetrafluoroethylene (PTFE) surface, including a contact angle of less than 77°, including a contact angle of less than 75°. In accordance with the present disclosure, the inventive hypohalite-based disinfecting compositions have an equilibrium contact angle of less than 65° when applied to an exemplary hydrophilic boron nitride surface, including a contact angle of less than 60°.

The hypohalite-based disinfecting compositions of the present invention may be employed on a wide variety of surfaces or substrates, including hard surfaces, soft surfaces, non-living (inanimate) surfaces, soil, porous, and non-porous surfaces. Embodiments of the present disclosure may be employed to disinfect or otherwise sanitize hard surfaces and inanimate objects. One surprising feature of the inventive hypohalite-based disinfecting compositions is the compatibility of the compositions with a number of diverse surfaces including, e.g., stainless steel. The inventive hypohalite-based disinfecting compositions exhibit lower residue, e.g., less visible streaking and/or spotting, than other comparable bleach compositions. Such residue, or film, left behind has been found undesirable by users. It is believed that the improved residue profile of the inventive hypohalite-based disinfecting compositions is attributable to the lower surface tension achieved by these compositions, as opposed to conventional bleach formulations.

The United States Environmental Protection Agency (EPA) publishes guidance regarding the human safety profile of disinfecting compositions under its “Design for the Environment” (“DfE”) policy. One feature of achieving the EPA's DfE classification is that a composition falls within the least hazardous classes (i.e., Category III or Category IV) of the EPA's “Acute Toxicity Category Hierarchy.” These toxicity categories are regulated under 40 CFR § 156.62 (Date: Jul. 1, 2014). One feature of the EPA toxicity categories is eye irritation. A product classified as Category III, upon exposure, exhibits “no corneal opacity; irritation reversible within 7 days,” and a product classified as category IV exhibits “no irritation.” In accordance with the present disclosure, the inventive hypohalite-based disinfecting compositions are categorized as at least Category III compositions, and in some embodiments, as Category IV compositions.

In accordance with the present disclosure, the hypohalite-based disinfecting compositions of the present invention may be formulated as liquids. For example, the hypohalite-based disinfecting compositions may be formulated as liquids that are poured, pumped, sprayed, dipped, rolled, or otherwise dispensed, including liquid concentrates and dilutable liquids. Other embodiments of the present disclosure include the hypohalite-based disinfecting compositions formulated as a spray. In some embodiments of the present disclosure, the hypohalite-based disinfecting compositions may be delivered in or on a wipe, i.e. a woven or nonwoven tissue, cloth, or substrate that is impregnated with a liquid and wiped over a surface.

In accordance with the present disclosure, the hypohalite-based disinfecting compositions of the present invention may be delivered in or on a wipe, such as, e.g., a pre-moistened wipe. Any wipe substrate compatible with the hypohalite ingredient may be used. In some embodiments, the wipe substrates comprise synthetic ingredients. In some embodiments, the wipe substrates comprise a single polymer or a mixture of two or more polymers. In some embodiments, the wipe substrates comprise polyethylene terephthalate (PET), polyester (PE), high density polyethylene (HDPE), polyvinyl chloride (PVC), chlorinated polyvinylidene chloride (CPVC), polyacrylamide (ACAM), polystyrene (PS), polypropylene (PP), polycarbonate (PC), polyaryletherketone (PAEK), poly(cyclohexylene dimethylene cyclohexanedicarboxylate) (PCCE), poly(cyclohexylene dimethylene terephthalate) (PCTA), poly(cyclohexylene dimethylene terephthalate) glycol (PCTG), polyetherimide (PEI), polyethersulfone (PES), poly(ethylene terephthalate) glycol (PETG), polyketone (PK), poly(oxymethylene); polyformaldehyde (POMF), poly(phenylene ether) (PPE), poly(phenylene sulfide) (PPS), poly(phenylene sulfone) (PPSU), syndiotactic polystyrene (syn-PS), polysulfone (PSU), polytetrafluoroethylene (PTFE), polyurethane (PUR), poly(vinylidene fluoride) (PVDF), polyamide thermoplastic elastomer (TPA), polybutylene (PB), polybutylene terephthalate (PBT), polypropylene terephthalate (PPT), polyethylene naphthalate (PEN), polyhydroxyalkanoate (PHA), poly(methyl)methacrylate (PMMA), polytrimethylene terephthalate (PTT), or combinations thereof. In some embodiments, the wipe substrates comprise polyethylene terephthalate (PET), polypropylene (PP), or combinations thereof. Due to incompatibility with the hypohalite ingredient, the wipe substrates may be devoid of cellulose or other naturally sourced materials. In accordance with the present disclosure, the ratio of hypohalite-based disinfecting composition to wipe substrate may be from 0.1:1 to 10:1 by weight, including from 2:1 to 6:1, including from 3:1 to 5:1.

The following paragraphs provide further non-limiting exemplary embodiments.

Paragraph 1. A disinfecting composition comprising: greater than 0.5 wt. % of a hypohalite ingredient, based upon the total weight of the disinfecting composition; and a surfactant blend, the surfactant blend comprising: a first surfactant having a first surfactant surface tension T¹; and a second surfactant having a second surfactant surface tension T², wherein the second surfactant has an average tail chain length that is different than the first surfactant, and wherein the second surfactant has a head group that is different than the first surfactant, and wherein the disinfecting composition has an overall surface tension T, wherein T is less than T¹, and wherein T is less than T².

Paragraph 2. The disinfecting composition of paragraph 1, wherein the overall surface tension T of the disinfecting composition is 28 mN/m or less.

Paragraph 3. The disinfecting composition of paragraph 1 or paragraph 2, wherein the difference between T and T¹ is 0.8 mN/m or more, and wherein the difference between T and T² is 0.8 mN/m or more.

Paragraph 4. The disinfecting composition of any one of paragraphs 1-3, wherein the difference between T and T¹ is 1 mN/m or more, and wherein the difference between T and T² is 1 mN/m or more.

Paragraph 5. The disinfecting composition of any one of paragraphs 1-4, wherein the difference between T and T¹ is 1.5 mN/m or more, and wherein the difference between T and T² is 1.5 mN/m or more.

Paragraph 6. The disinfecting composition of any one of paragraphs 1-5, wherein the difference between T and T¹ is 2 mN/m or more, and wherein the difference between T and T² is 2 mN/m or more.

Paragraph 7. The disinfecting composition of any one of paragraphs 1-6, wherein the first surfactant has an average tail chain length of a C10 to C14 value and the second surfactant has an average tail chain length of a different C10 to C14 value than the first surfactant.

Paragraph 8. The disinfecting composition of any one of paragraphs 1-7, wherein the first surfactant has an average tail chain length of a C12 to C14 value and the second surfactant has an average tail chain length of a different C12 to C14 value than the first surfactant.

Paragraph 9. The disinfecting composition of any one of paragraphs 1-8, wherein the first surfactant consists of an anionic surfactant and the second surfactant consists of a zwitterionic surfactant.

Paragraph 10. The disinfecting composition of any one of paragraphs 1-9, wherein the first surfactant is selected from the group consisting of sodium lauryl sulfate and sodium myristyl sulfate.

Paragraph 11. The disinfecting composition of any one of paragraphs 1-10, wherein the second surfactant is selected from the group consisting of myristamine oxide and cocobetaine.

Paragraph 12. A disinfecting composition comprising: greater than 0.5 wt. % of a hypohalite ingredient, based upon the total weight of the disinfecting composition; and a surfactant blend comprising a first surfactant and a second surfactant, wherein the second surfactant has an average tail chain length value that is different than the first surfactant, and wherein the second surfactant has a head group that is different than the first surfactant, wherein the disinfecting composition has an overall surface tension T of 28 mN/m or less.

Paragraph 13. The disinfecting composition of paragraph 12, wherein the first surfactant has an average tail chain length of a C10 to C14 value and the second surfactant has an average tail chain length of a different C10 to C14 value than the first surfactant.

Paragraph 14. The disinfecting composition of paragraph 12 or paragraph 13, wherein the first surfactant has an average tail chain length of a C12 to C14 value and the second surfactant has an average tail chain length of a different C12 to C14 value than the first surfactant.

Paragraph 15. The disinfecting composition of any one of paragraphs 12-14, wherein the first surfactant consists of an anionic surfactant and the second surfactant consists of a zwitterionic surfactant.

Paragraph 16. The disinfecting composition of any one of paragraphs 12-15, wherein the first surfactant is selected from the group consisting of sodium lauryl sulfate and sodium myristyl sulfate.

Paragraph 17. The disinfecting composition of any one of paragraphs 12-16, wherein the second surfactant is selected from the group consisting of myristamine oxide and cocobetaine.

Paragraph 18. A disinfecting composition comprising: greater than 0.5 wt. % of a hypohalite ingredient, based upon the total weight of the disinfecting composition; and a surfactant blend, the surfactant blend comprising: an anionic surfactant having a first surfactant surface tension T¹; and a zwitterionic surfactant having a second surfactant surface tension T², wherein the zwitterionic surfactant has an average tail chain length that is different than the anionic surfactant, and wherein the disinfecting composition has an overall surface tension T, and wherein the difference between T and T¹ is 0.8 mN/m or more, and wherein the difference between T and T² is 0.8 mN/m or more.

Paragraph 19. The disinfecting composition of paragraph 18, wherein both T¹-T and T²-T, individually, are 1 mN/m or more, preferably 1.5 mN/m or more, preferably 2 mN/m or more.

Paragraph 20. The disinfecting composition of paragraph 18 or paragraph 19, wherein T is 28 mN/m or less.

The general inventive concepts have been described above both generally and with regard to various specific exemplary embodiments. Although the general inventive concepts have been set forth in what are believed to be exemplary illustrative embodiments, a wide variety of alternatives will be apparent to those of skill in the art from reading this disclosure. The general inventive concepts are not otherwise limited, except for those instances when presented in specific claims.

### EXAMPLES

The following examples are included for the purposes of illustration, and do not limit the scope of the general inventive concepts described herein.

### Example 1

In accordance with the present disclosure, it was found that intentionally blending two or more surfactants having different average tail lengths and different head groups leads to a superior (i.e., lower) overall surface tension of a hypohalite-based disinfecting composition. Various combinations of surfactants were tested with respect to the surface tension of hypohalite-based disinfecting compositions comprising the surfactant blend. Specifically, exemplary blends were prepared using varying surfactants having an average tail chain length of a C10 to C14 value. The surfactant blends were tested at varying molar ratios.

Accordingly, each surfactant blend comprised a first surfactant having a first surfactant surface tension T¹ and a second surfactant having a second surfactant surface tension T². The respective overall surface tension T for each surfactant blend was thereafter tested, using the Wilhelmy plate method.

In accordance with the present invention, it was surprisingly found that some surfactant blends provide an overall surface tension T that is less than the individual surface tensions T¹ and T², respectively.

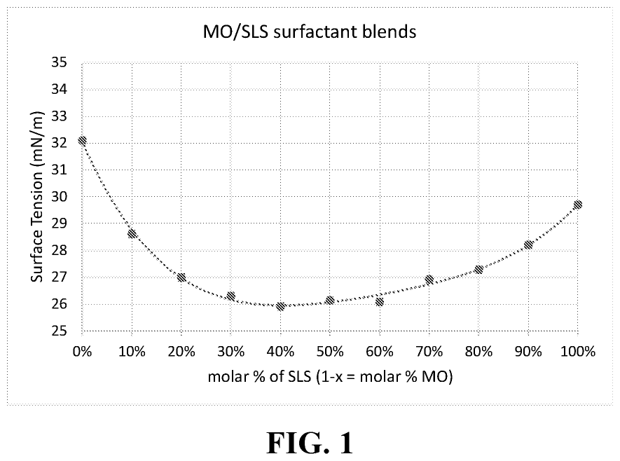

FIG. 1 is a line plot showing the surface tension of otherwise identical hypohalite-based disinfecting compositions comprising varying levels of SLS/MO surfactant blends. Sodium lauryl sulfate (SLS) is an anionic surfactant with an average carbon chain length of 12 carbons, and myristamine oxide (MO) is a zwitterionic surfactant with an average chain length of 14 carbons. The y-axis shows the overall surface tension T. As shown in FIG. 1, a molar ratio of sodium lauryl sulfate to myristamine oxide (i.e., [SLS]: [MO]) of from 7:1 to 1:9 met the success criteria (i.e., an overall surface tension T of 28 mN/m or less, and an overall surface tension T that is less than the individual surfactant surface tensions T¹ and T², respectively). In viewing FIG. 1, it can be seen that the individual surfactant surface tensions are shown for myristamine oxide (32.1 mN/m, i.e., the value of MO at 0% SLS in the blend) and for sodium lauryl sulfate (29.7 mN/m, i.e., the value of SLS at 100% SLS in the blend).

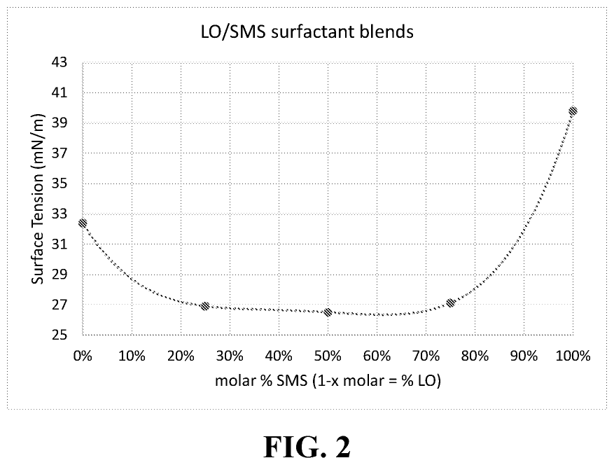

FIG. 2 is a line plot showing the surface tension of otherwise identical hypohalite-based disinfecting compositions comprising varying levels of SMS/LO surfactant blends. Sodium myristyl sulfate (SMS) is an anionic surfactant with an average carbon chain length of 14 carbons, and lauramine oxide (LO) is a zwitterionic surfactant with an average chain length of 12 carbons. As shown in FIG. 2, a molar ratio of sodium myristyl sulfate to lauramine oxide (i.e., [SMS]: [LO]) of from at least 3:1 to 1:3 met the success criteria (i.e., an overall surface tension T of 28 mN/m or less, and an overall surface tension T that is less than the individual surfactant surface tensions T¹ and T², respectively). In viewing FIG. 2, it can be seen that the individual surfactant surface tensions are shown for lauramine oxide (32.4 mN/m, i.e., the value of LO at 0% SMS in the blend) and for sodium myristyl sulfate (39.8 mN/m, i.e., the value of SMS at 100% SMS in the blend).

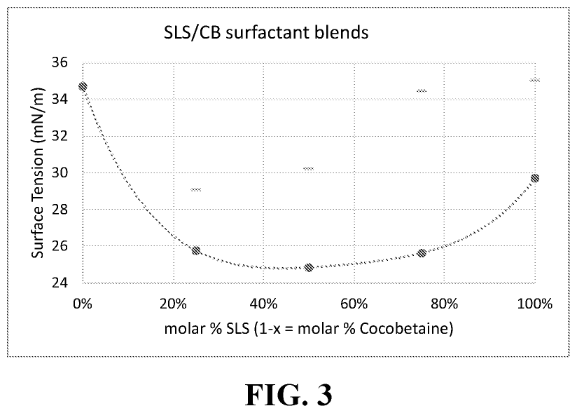

FIG. 3 is a line plot showing the surface tension of otherwise identical hypohalite-based disinfecting compositions comprising varying levels of SLS/CB surfactant blends. Sodium lauryl sulfate (SLS) is an anionic surfactant with an average carbon chain length of 12 carbons, and cocobetaine (CB) is a zwitterionic surfactant with an average chain length of 12.7 carbons. As shown in FIG. 3, a molar ratio of sodium lauryl sulfate to cocobetaine (i.e., [SLS]: [CB]) of from at least 3:1 to 1:3 met the success criteria (i.e., an overall surface tension T of 28 mN/m or less, and an overall surface tension T that is less than the individual surfactant surface tensions T¹ and T², respectively). In viewing FIG. 3, it can be seen that the individual surfactant surface tensions are shown for cocobetaine (34.7 mN/m, i.e., the value of CB at 0% SLS in the blend) and for sodium lauryl sulfate (29.7 mN/m, i.e., the value of SLS at 100% SLS in the blend).

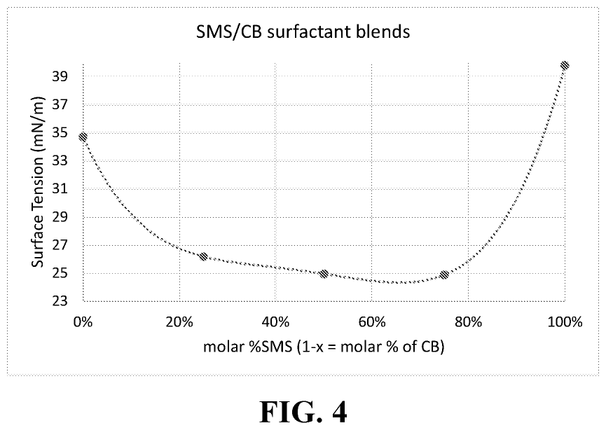

FIG. 4 is a line plot showing the surface tension of otherwise identical hypohalite-based disinfecting compositions comprising varying levels of SMS/CB surfactant blends. Sodium myristyl sulfate (SMS) is an anionic surfactant with an average carbon chain length of 14 carbons, and cocobetaine (CB) is a zwitterionic surfactant with an average chain length of 12.7 carbons. As shown in FIG. 4, a molar ratio of sodium myristyl sulfate to cocobetaine (i.e., [SMS]: [CB]) of from at least 3:1 to 1:3 met the success criteria (i.e., an overall surface tension T of 28 mN/m or less, and an overall surface tension T that is less than the individual surfactant surface tensions T¹ and T², respectively). In viewing FIG. 4, it can be seen that the individual surfactant surface tensions are shown for cocobetaine (34.7 mN/m, i.e., the value of CB at 0% SMS in the blend) and for sodium myristyl sulfate (39.8 mN/m, i.e., the value of SMS at 100% SMS in the blend).

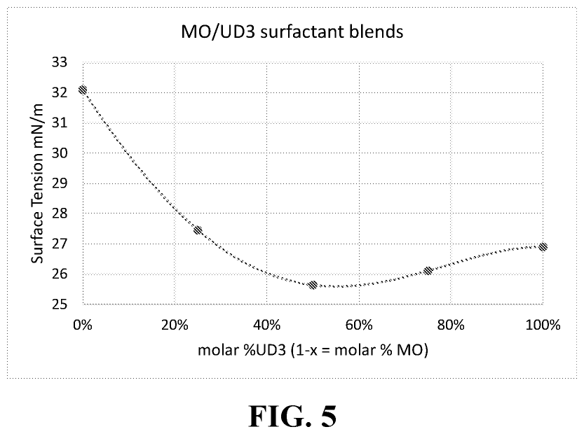

FIG. 5 is a line plot showing the surface tension of otherwise identical hypohalite-based disinfecting compositions comprising varying levels of UD3/MO surfactant blends. Undeceth-3 (UD3) is a nonionic surfactant with an average carbon chain length of 11 carbons, and myristamine oxide (MO) is a zwitterionic surfactant with an average chain length of 14 carbons. As shown in FIG. 5, a molar ratio of undeceth-3 to myristamine oxide (i.e., [UD3]:[MO]) of from at least 3:1 to 1:1 met the success criteria (i.e., an overall surface tension T of 28 mN/m or less, and an overall surface tension T that is less than the individual surfactant surface tensions T¹ and T², respectively). In viewing FIG. 5, it can be seen that the individual surfactant surface tensions are shown for myristamine oxide (32.1 mN/m, i.e., the value of MO at 0% UD3 in the blend) and for undeceth-3 (26.9 mN/m, i.e., the value of UD3 at 100% UD3 in the blend).

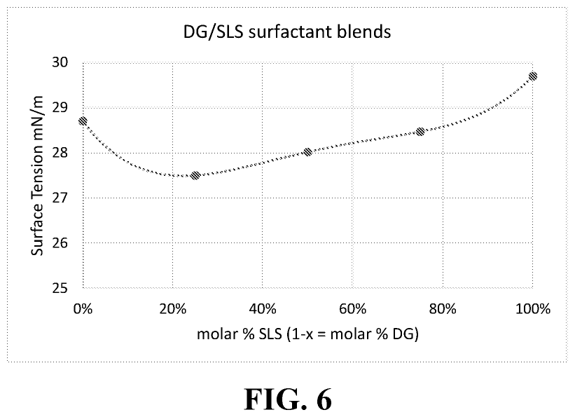

FIG. 6 is a line plot showing the surface tension of otherwise identical hypohalite-based disinfecting compositions comprising varying levels of SLS/DG surfactant blends. Sodium lauryl sulfate (SLS) is an anionic surfactant with an average carbon chain length of 12 carbons, and decyl glucoside (DG) is a nonionic surfactant with an average chain length of 10 carbons. As shown in FIG. 6, a molar ratio of sodium lauryl sulfate to decyl glucoside (i.e., [SLS]:[DG]) of from at least 1:1 to 1:3 met the success criteria (i.e., an overall surface tension T of 28 mN/m or less, and an overall surface tension T that is less than the individual surfactant surface tensions T¹ and T², respectively). In viewing FIG. 6, it can be seen that the individual surfactant surface tensions are shown for decyl glucoside (28.7 mN/m, i.e., the value of DG at 0% SLS in the blend) and for sodium lauryl sulfate (29.7 mN/m, i.e., the value of SLS at 100% SLS in the blend).

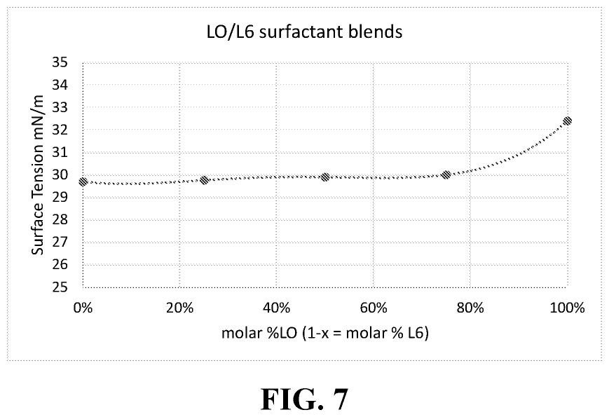

FIG. 7 is a line plot provided for comparative purposes showing the surface tension of otherwise identical hypohalite-based disinfecting compositions comprising varying levels of LO/L6 surfactant blends. Lauramine oxide (LO) is a zwitterionic surfactant with an average chain length of 12 carbons, and laureth-6 (L6) is a nonionic surfactant with an average chain length of 12 carbons. Accordingly, the two surfactants have different head groups, but identical average tail chain lengths. In viewing FIG. 7, it can be seen that the individual surfactant surface tensions are shown for laureth-6 (29.7 mN/m, i.e., the value of L6 at 0% LO in the blend) and for lauramine oxide (32.4 mN/m, i.e., the value of LO at 100% LO in the blend). As shown in FIG. 7, the LO/L6 surfactant blend did not meet the success criteria established for the instant invention. Specifically, the blend did not provide an overall surface tension T of 28 mN/m or less. Moreover, as shown in FIG. 7, the blend did not provide an overall surface tension T that is less than both of the individual surfactant surface tensions T¹ and T², respectively.

What is claimed is:

1. A disinfecting composition comprising:
greater than 0.5 wt. % of a hypohalite ingredient, based upon the total weight of the disinfecting composition; and
a surfactant blend, the surfactant blend comprising:
a first surfactant having a first surfactant surface tension T₁; and
a second surfactant having a second surfactant surface tension T² ,
wherein the second surfactant has an average tail chain length that is different than the first surfactant, and wherein the second surfactant has a head group that is different than the first surfactant, and
wherein the disinfecting composition has an overall surface tension T, wherein T is less than T¹, and wherein T is less than T².

2. The disinfecting composition of claim 1, wherein the overall surface tension T of the disinfecting composition is 28 mN/m or less.

3. The disinfecting composition of claim 1, wherein the difference between T and T¹ is 0.8 mN/m or more, and wherein the difference between T and T² is 0.8 mN/m or more.

4. The disinfecting composition of claim 1, wherein the difference between T and T¹ is 1 mN/m or more, and wherein the difference between T and T² is 1 mN/m or more.

5. The disinfecting composition of claim 1, wherein the difference between T and T¹ is 1.5 mN/m or more, and wherein the difference between T and T² is 1.5 mN/m or more.

6. The disinfecting composition of claim 1, wherein the difference between T and T¹ is 2 mN/m or more, and wherein the difference between T and T² is 2 mN/m or more.

7. The disinfecting composition of claim 1, wherein the first surfactant has an average tail chain length of a C10 to C14 value and the second surfactant has an average tail chain length of a different C10 to C14 value than the first surfactant.

8. The disinfecting composition of claim 1, wherein the first surfactant has an average tail chain length of a C12 to C14 value and the second surfactant has an average tail chain length of a different C12 to C14 value than the first surfactant.

9. The disinfecting composition of claim 1, wherein the first surfactant consists of an anionic surfactant and the second surfactant consists of a zwitterionic surfactant.

10. The disinfecting composition of claim 1, wherein the first surfactant is selected from the group consisting of sodium lauryl sulfate and sodium myristyl sulfate.

11. The disinfecting composition of claim 10, wherein the second surfactant is selected from the group consisting of myristamine oxide and cocobetaine.

12. A disinfecting composition comprising:
greater than 0.5 wt. % of a hypohalite ingredient, based upon the total weight of the disinfecting composition; and
a surfactant blend comprising a first surfactant and a second surfactant, wherein the second surfactant has an average tail chain length value that is different than the first surfactant, and wherein the second surfactant has a head group that is different than the first surfactant, wherein the disinfecting composition has an overall surface tension T of 28 mN/m or less.

13. The disinfecting composition of claim 12, wherein the first surfactant has an average tail chain length of a C10 to C14 value and the second surfactant has an average tail chain length of a different C10 to C14 value than the first surfactant.

14. The disinfecting composition of claim 12, wherein the first surfactant has an average tail chain length of a C12 to C14 value and the second surfactant has an average tail chain length of a different C12 to C14 value than the first surfactant.

15. The disinfecting composition of claim 12, wherein the first surfactant consists of an anionic surfactant and the second surfactant consists of a zwitterionic surfactant.

16. The disinfecting composition of claim 12, wherein the first surfactant is selected from the group consisting of sodium lauryl sulfate and sodium myristyl sulfate.

17. The disinfecting composition of claim 16, wherein the second surfactant is selected from the group consisting of myristamine oxide and cocobetaine.

18. A disinfecting composition comprising:
greater than 0.5 wt. % of a hypohalite ingredient, based upon the total weight of the disinfecting composition; and
a surfactant blend, the surfactant blend comprising:
an anionic surfactant having a first surfactant surface tension T¹; and
a zwitterionic surfactant having a second surfactant surface tension T²,
wherein the zwitterionic surfactant has an average tail chain length that is different than the anionic surfactant, and
wherein the disinfecting composition has an overall surface tension T, and wherein the difference between T and T¹ is 0.8 mN/m or more, and wherein the difference between T and T² is 0.8 mN/m or more.

19. The disinfecting composition of claim 18, wherein both T¹-T and T²-T, individually, are 1 mN/m or more.

20. The disinfecting composition of claim 18, wherein T is 28 mN/m or less.
